(19) United States
(12) Patent Application Publication
(10) Pub. No.: US 2026/0018697 A1
(43) Pub. Date: Jan. 15, 2026

(54) DEVICE FOR THERMAL REGULATION, IN PARTICULAR FOR COOLING

(71) Applicant: VALEO SYSTEMES THERMIQUES, Le Mesnil-Saint-Denis (FR)

(72) Inventors: Cédric De-Vaulx, Le Mesnil-Saint-Denis Cedex (FR); Kamel Azzouz, Le Mesnil-Saint-Denis Cedex (FR); Erwan Etienne, Le Mesnil-Saint-Denis Cedex (FR); Jean-Christophe Lhermitte, Le Mesnil-Saint-Denis Cedex (FR); Jeremy Blandin, Le Mesnil-Saint-Denis Cedex (FR)

(73) Assignee: VALEO SYSTEMES THERMIQUES, Le Mesnil-Saint-Denis (FR)

(21) Appl. No.: 18/992,095

(22) PCT Filed: Jul. 3, 2023
(86) PCT No.: PCT/EP2023/068234

§ 371 Date: Jan. 7, 2025

(30) Foreign Application Priority Data
Jul. 7, 2022 (FR) FR2206955

(51) Int. Cl. H01M 10/6556; H01M 10/613; H01M 10/6568

(52) U.S. Cl. CPC H01M 10/6556; H01M 10/613; H01M 10/6568

(57) ABSTRACT

A device for thermal regulation, for a component that is liable to release heat during operation, includes a circulation network for a heat-transfer fluid, the circulation network includes a fluid flow channel, and a mixing member. The mixing chamber includes openings that are arranged so as to cause the fluid circulating in the channel to be successively separated and mixed.

The present invention relates to a device for thermal regulation, in particular for cooling, in particular for an electrical component that is liable to release heat during operation, in particular to a device for cooling at least one battery or battery cells of a vehicle, for example a motor vehicle.

The vehicle may be a land vehicle, marine vehicle or air vehicle.

The invention relates in particular to plate heat exchangers intended to circulate a heat-transfer fluid, for example a refrigerant fluid or glycol water, for cooling the batteries of hybrid or electric vehicles. The first plate, or upper plate, which comes into contact with the components to be cooled, is generally planar. The second plate, or lower plate, is a stamped plate in which circulation channels for the heat-transfer fluid are formed.

In a known manner, in order to increase turbulence in the heat-transfer fluid, which has the effect of increasing the exchange coefficient and therefore the thermal performance, two types of elements can be used.

First of all, there are elements referred to as “hard dimples”, which are bosses establishing the connection between the lower plate and the upper plate. These bosses provide the mechanical connection of the assembly, while at the same time ensuring a minimum level of disturbance of the coolant. These bosses are mechanically robust, but their thermal performance is not optimized. Specifically, by passing through the circulation channels over their entire height, the bosses produce significant pressure losses without, however, creating enough turbulence for the increase in thermal performance to compensate for this pressure loss.

There are also elements referred to as “soft dimples”, which are bosses inside the circulation channels, but which have a lower height so as to be recessed from the upper plate. These bosses do not contribute to the mechanical strength of the cooling plates but ensure a significant level of turbulence in the fluid. Patent application DE102014202161 describes such bosses.

The invention aims to improve the homogeneity in terms of temperature of the heat-transfer fluid circulating in the circulation network.

The invention thus proposes a device for thermal regulation, in particular for cooling, for a component that is liable to release heat during operation, in particular for an electrochemical energy storage module, this device having a circulation network for a heat-transfer fluid, this network comprising:
a fluid flow channel,
a mixing member comprising openings that are arranged so as to cause the fluid circulating in the channel to be successively separated and mixed.

In the heat-transfer fluid circulation network, a wall layer of fluid, which is on or in the vicinity of a heat exchange wall, is heated more than an inner layer, which is further away from this wall. The inner layer and the wall layer extend one another more or less continuously in terms of temperature.

In the invention, the fluid mixing aims to attenuate, or even eliminate, this temperature gradient within the fluid. The invention allows wall layers of fluid and inner layers of fluid to be effectively mixed.

Preferably, the channel comprises at least one wall formed by a plate or a tube, and this plate or this tube, on the one hand, and the mixing member, on the other hand, are separate parts.

According to one of the aspects of the invention, the plate or the tube, and the mixing member are made from different materials.

For example, the mixing member is made of plastics material or plastics-based composite material, and the plate or the tube is made of metal, for example aluminum or steel.

According to one of the aspects of the invention, the mixing member is in the form of an additional member that is placed in the channel.

According to one of the aspects of the invention, the openings are perpendicular to the general direction of flow of the fluid in the device.

According to one of the aspects of the invention, the channel and the mixing member are arranged so as to define at least one separation zone (51), preferably at least two separation zones, the at least one separation zone being arranged so as to separate the flow of fluid into at least two separated streams and, downstream, a mixing zone in which the two separated streams mix.

According to one of the aspects of the invention, the separated streams have a parallel portion before being rejoined in the mixing zone.

According to one of the aspects of the invention, the two separated streams lead into the mixing zone at respective angles that are selected so as to generate a mixture of wall layers of fluid and inner layers of fluid in the mixing zone.

According to one of the aspects of the invention, the number of separated streams that are recombined in the mixing zone is exactly two.

According to one of the aspects of the invention, the angle of incidence between the two streams of fluid leading into the mixing zone is between 45° and 90°, the angle being defined in particular with respect to the z axis, i.e. the axis intersecting the 2 plates perpendicularly.

The abovementioned angles are selected so that all of the layers mix. An excessively small angle of incidence between the fluid flows does not allow the layers to be mixed effectively because these streams would then be “too tangential” to one another.

The invention thus makes it possible to homogenize the temperature of the fluid over the entire cross section of the flow, namely over the wall and at the center of the flow. The fluid can thus have a lower temperature on the wall, which acts as a thermal interface in order to offer a better heat exchange with the component to be cooled.

In the present invention, the mixing can take place at relatively low speeds of the fluid, said mixing being chaotic by virtue of the angles selected for the two flows that lead into the mixing zone. The chaotic mixing principle is used in particular for mixing viscous fluids at low speeds. In a known manner, the chaotic mixing is based on the “baker's map” for mixing the different layers of fluid. For example, according to one manner of carrying out this map, the layers of fluid are passively divided, then rotated through turns with different chiralities, and finally recombined in order to obtain elongation and folding to ensure homogeneous mixing.

In the invention, the mixture is not necessarily turbulent if the speed, or the Reynolds number, does not exceed a certain threshold. The invention can thus enable mixing at a low speed or at a low Reynolds number, typically at a Reynolds number Re lower than 2000, in particular between 100 and 1400. This is particularly advantageous when the thermal regulation device is operating with fluid flow speeds that are insufficient for generating turbulent flows.

The invention makes it possible to mix the layers of fluid without generating excessive pressure losses, unlike turbulence in particular, which is a source of large pressure losses.

According to one of the aspects of the invention, the angle of incidence between the two flows of fluid leading into the mixing zone is between 45° and 90°, or between 70° and 90°. The angle may be equal to 90°.

According to one of the aspects of the invention, the channel has a length that is measured in the general direction of flow of the heat-transfer fluid, and the mixing member extends over at least 50% of the length of the channel, in particular over at least 70% or 80% or 90% of the length of the channel.

According to one of the aspects of the invention, the channel extends between a fluid outlet and inlet, and the mixing member extends from the fluid inlet toward the fluid outlet.

According to one of the aspects of the invention, the mixing member and the channel are configured to generate fluid streams that are in at least two parallel planes that are spaced apart from one another by a height.

Thus, the flow of fluid can be subdivided into separate streams that pass above the mixing member and below this mixing member, respectively. These streams are stepped in the direction of height.

According to one of the aspects of the invention, the flow thus occurs locally in a direction perpendicular to the abovementioned parallel planes.

According to one of the aspects of the invention, the fluid network thus has a three-dimensional configuration, with fluid streams in two separate planes and streams that join the two planes.

According to one of the aspects of the invention, the flow can be subdivided and distributed into a number of planes, or levels, that is greater than 2.

According to one of the aspects of the invention, the mixing member and the channel are configured to define a plurality of elementary patterns each formed by a fluid separation zone and the mixing zone associated therewith.

According to the invention, the streams that leave the separation zone and that regroup in the mixing zone are preserved, in the sense that they do not receive any additional streams of fluid on this path between the separation zone and the mixing zone.

According to one of the aspects of the invention, the sum of the cross sections of the streams that leave the mixing zone separately is substantially equal to the cross section of the mixing zone.

According to one of the aspects of the invention, the distance between the centers of two successive patterns corresponds to the size of the pattern, all of these dimensions being measured in the same direction.

These patterns may be further apart from one another. Specifically, the recombination advantageously enables much better mixing than is conventionally achieved in the prior art. As a result, such a recombination enables homogeneous mixing downstream and enables said patterns to be spaced apart.

According to one of the aspects of the invention, the openings in the mixing member are identical and are regularly spaced apart from one another.

According to one of the aspects of the invention, the space between the first opening and the last opening of a row represents at least 50%, or even at least 80% or 90%, of the dimension of the mixing member, said dimension being measured parallel to this row.

Thus, the openings occupy a large surface area of the mixing member.

According to one of the aspects of the invention, the mixing member comprises at least two parallel rows, or even at least three parallel rows, of openings.

According to one of the aspects of the invention, the number of rows and the number of patterns in each row can be selected on the basis of the cooling performance required.

According to one of the aspects of the invention, each opening comprises a longitudinal branch to which two transverse branches are connected.

It is possible to adapt the passage section in order to limit the problems of excessive pressure loss. In this case, it is sufficient to enlarge the imprint of the patterns of the mixing member.

According to one of the aspects of the invention, the mixing member has a periphery that is adapted to the form of the channel in which it is placed.

According to one of the aspects of the invention, the mixing member has a polygonal periphery, for example a generally rectangular periphery.

According to one of the aspects of the invention, the mixing member has an elongate periphery in order to closely match the form of the channel.

According to one of the aspects of the invention, each channel receives a mixing member, which is an additional member that is placed in the channel.

According to one of the aspects of the invention, the mixing member is made of plastics material, in particular by injection molding plastics material.

According to one of the aspects of the invention, the mixing member is a monolithic part arranged so as to orient the fluid streams.

In this case, the openings in the mixing member are configured, in particular, to define cylindrical portions for the passage of fluid.

According to another of the aspects of the invention, the mixing member has at least two assembled sheets, these sheets being provided with circulation orifices that together form the openings in the mixing member that define fluid bifurcations and intersections.

The two sheets can replace the abovementioned monolithic mixing member.

In this example, the fluid separation and recombination paths are formed mainly by the two sheets.

According to one aspect of the invention, the sheets are adhesively bonded to one another.

In a variant, the sheets are laser welded to one another. This is advantageous in order to avoid the sheets being heated when they are made of a plastics-based composite material filled with reinforcing elements such as glass fibers or carbon fibers.

According to one aspect of the invention, the mixing member is placed between two planar faces respectively forming two main faces of the flow channels.

According to one aspect of the invention, these planar faces belong to upper and lower plates between which the mixing member is placed.

In this exemplary embodiment of the invention, it is mainly the mixing member that orients the fluid streams, the upper and lower plates mainly acting as casing for the channels, without the role of orienting the fluid for separating and recombining the streams.

According to one aspect of the invention, the lower plate comprises grooves forming, with the upper plate, which is planar, the channels, which are in particular parallel.

According to one aspect of the invention, each channel receives an associated mixing member.

According to one aspect of the invention, the grooves in the lower plate are formed by stamping the plate.

According to another of the aspects of the invention, the mixing member, which is in particular made of metal, is placed in a tank, and this mixing member and this tank together define the fluid flow channels.

According to one aspect of the invention, the tank is formed by a lower plate and closed by an upper plate, which is in particular planar, and the mixing member bears against the two plates forming the tank, in particular covering the entire flat bottom of the tank.

In this example, the neighboring channels are separated by the mixing member rather than by the lower plate, which is planar on the bottom.

The invention thus makes it possible to easily produce the two lower and upper plates, which do not require any complex stamped forms.

According to another of the aspects of the invention, the mixing member has at least two assembled metal sheets, these sheets being provided with circulation orifices that together form the openings in the mixing member.

According to one aspect of the invention, the openings in the mixing member define fluid bifurcations and intersections by means of the presence of portions, in particular cylindrical portions, formed by the mixing member.

In this example, the fluid separation and recombination paths are formed mainly by the two sheets.

According to one aspect of the invention, the sheets are aluminum-based, in particular being made of aluminum alloy.

According to one aspect of the invention, these sheets are assembled with the lower and upper plates, in particular these sheets being held, at their edge, between these lower and upper plates.

According to one aspect of the invention, this edge of the mixing member is then brazed to the lower and upper plates.

The invention makes it possible, with a brazing step, to assemble all of the plates and the sheets together.

According to one aspect of the invention, the fluid circulation network comprises a fluid flow portion (23) downstream of the mixing zone, such that the fluid flowing in this fluid flow portion has a relatively homogeneous temperature as a result of the mixing in the mixing zone, and said downstream flow portion has, in particular, a cross section for the passage of fluid that is larger, for example by a factor of 2, than each of the cross sections of the separated fluid flows.

According to one aspect of the invention, the separated flows of fluid that lead into the mixing zone are arranged in different planes (P1, P2).

In a variant, these sheets may be adhesively bonded to one another.

According to another of the aspects of the invention, the channels are formed by assembling a stamped plate and the mixing member, the stamped plate comprising forms for defining, with forms of the mixing member, the channels and zones for separating and mixing fluid.

According to one of the aspects of the invention, the stamped plate is a wall encasing the channels, for example the lower plate, which defines, with an upper plate, the fluid channels.

According to one aspect of the invention, the mixing member comprises a single sheet with the fluid circulation openings.

The openings in the sheet define, with the stamped forms of the plate, fluid bifurcations and intersections.

Thus, unlike preceding exemplary embodiments of the invention, a single sheet is used in this case.

According to one aspect of the invention, the stamped forms of the plate form patterns that are repeated so as to correspond to the openings in the mixing member.

According to one aspect of the invention, each stamped form comprises a longitudinal branch to which two transverse branches are connected.

According to one aspect of the invention, the stamped forms are dishes on the plate, which are arranged according to this branch configuration.

According to one aspect of the invention, this branch configuration has mirror symmetry that is offset with respect to the branch configuration of the patterns on the mixing member, in order to form the fluid bifurcations and intersections.

According to one aspect of the invention, the mixing member may be based on plastics material, composite material, ceramic or metal.

The invention also relates to an assembly having a component that is liable to release heat during operation, and to a thermal regulation device as described above, in contact with which the component is cooled.

According to one of the aspects of the invention, the heat-transfer fluid is a refrigerant fluid selected from the refrigerant fluids R134a, R1234yf and R744. In a variant, the heat-transfer fluid is glycol water.

Further features and advantages of the invention will become more clearly apparent upon reading the following description, which is given by way of illustrative and non-limiting examples, and from the appended drawings, in which:

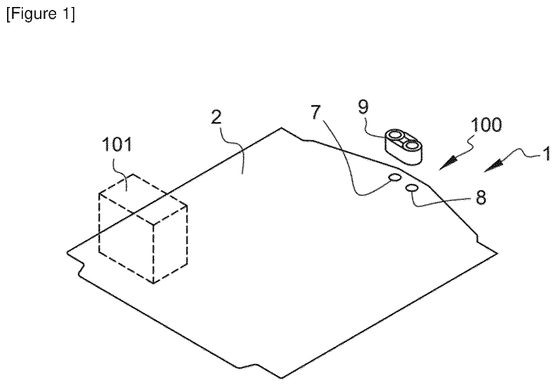

FIG. 1 schematically and partially illustrates a thermal regulation device,

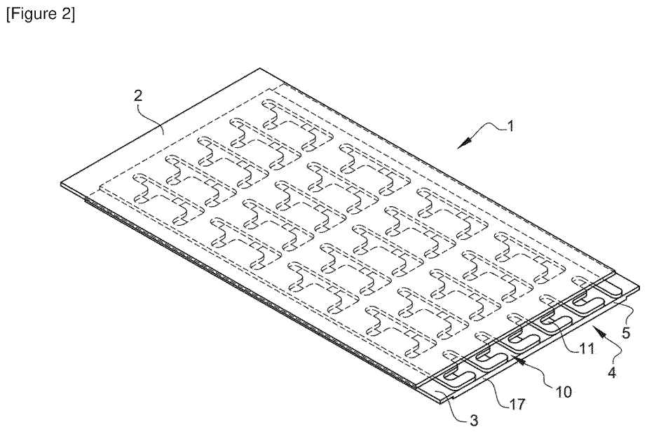

FIG. 2 schematically and partially illustrates the mixing member between the upper and lower plates of a thermal regulation device according to one exemplary embodiment of the invention,

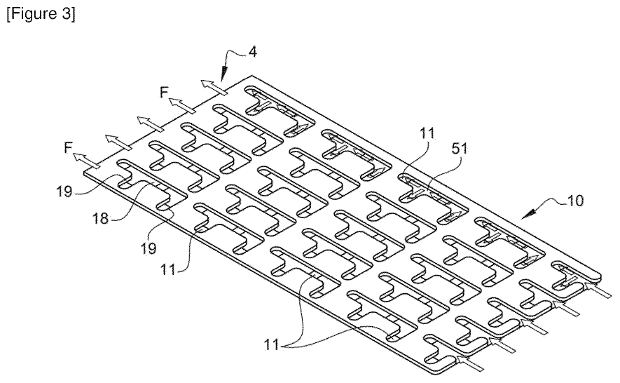

FIG. 3 schematically and partially illustrates, in isolation, the mixing member from FIG 2,

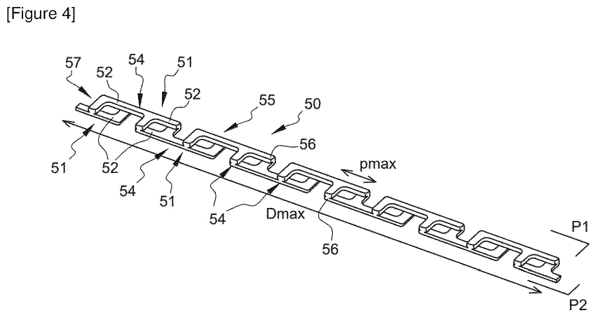

FIG. 4 schematically and partially illustrates the fluid path imposed by the mixing member from FIG. 3,

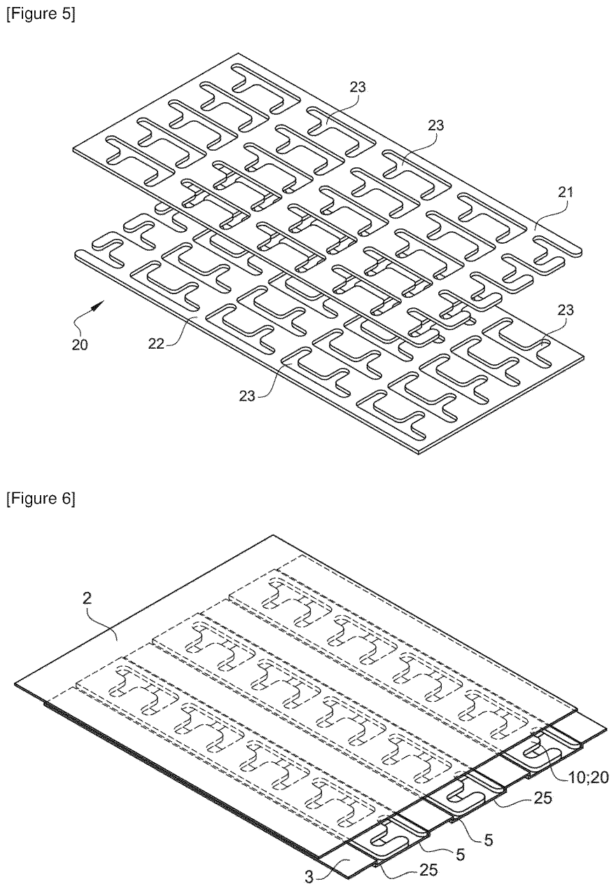

FIG. 5 schematically and partially illustrates a mixing member according to another exemplary embodiment of the invention,

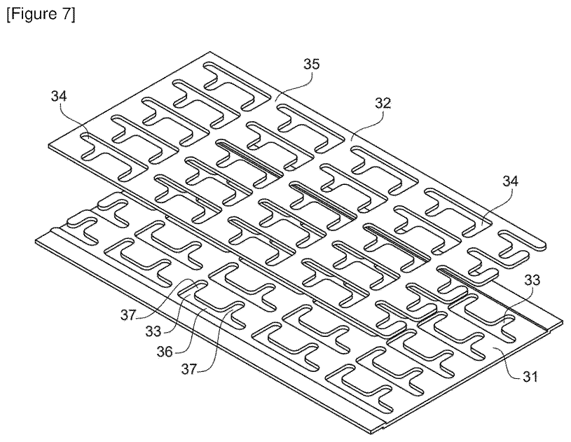

FIG. 6 schematically and partially illustrates yet another exemplary embodiment of the invention,

FIG. 7 schematically and partially illustrates another exemplary embodiment of the invention.

FIG. 1 shows an assembly 100 having a set of battery cells 101 to be cooled, which are for example arranged in a plurality of parallel rows, and a thermal regulation device 1 that is designed to cool the cells 101, which are in thermal contact with an upper plate of the cooling device 1, as explained below.

The thermal regulation device 1 has an upper plate 2 and a lower plate 3, which is assembled with the upper plate 2 in order to form together a circulation network 4 formed of a plurality of circulation channels 5 for a liquid heat-transfer fluid, in particular glycol water, as can be seen more clearly in FIG. 2.

A single channel 5 is shown in FIG. 2. The channels 5 may have different fluid paths, for example being provided with a U shape.

The direction of circulation of the fluid in the channels 5 is indicated by arrows F in FIG. 3, as will be explained in more detail below.

The channels 5 are supplied with fluid, via a fluid distribution region, not shown, which communicates with a fluid inlet 7. A fluid outlet 8 is also provided. A flange 9 can be connected to this inlet 7 and this outlet 8, in order to ensure connections to an external fluid circuit, which comprises, inter alia, a pump.

The circulation network 4 comprises, in addition to the channels 5, a mixing member 10 that is placed in each channel 5 and comprises openings 11 that are arranged so as to cause the fluid circulating in the associated channel 5 to be successively separated and mixed.

The channels 5 are formed between the lower plate 3 and the upper plate 2.

The mixing member 10 and the plates 2 and 3 are separate parts.

In the example described, the mixing member 10 is made of plastics material or plastics-based composite material, and the plates 2 and 3 are made of metal, for example aluminum or steel.

The mixing member 10 is in the form of an additional member that is placed in the channel 5.

FIG. 4 illustrates the path of the fluid in the network 4, said path being imposed by the mixing member 10.

As can be seen, the fluid circulation network 4 comprises successive separation zones 51 that each extend toward two separate portions 52 in which the flow is divided into two streams. These portions 52 are rejoined in mixing zones 54 in which the separated streams are recombined.

Each separation zone 51, then the separated portions 52 and the mixing zone 54 form an elementary pattern 55. The fluid circulation network 4 comprises a series of such patterns 55, which are regularly spaced apart by a predetermined pitch.

Each pattern 55 has a maximum dimension pmax, which is in this case measured in the longitudinal direction, which is at least 20, 15, 10 or 5 times smaller than the maximum dimension DMax of the fluid circulation network 4, which is also measured in the longitudinal direction.

In the example described, certain separated flows of the fluid portions 52 that lead into the mixing zone 54 are arranged in two different planes P1 and P2.

The fluid circulation network 4 generates flow turns 56 passing from one plane P1 or P2 to the other.

The planes P1 and P2, which are parallel to the plates 2 and 3, are separated by a predetermined height measured perpendicular to these planes.

The heat-transfer fluid thus circulates from one plane P1 or P2 to the other. When they are joined or recombined, the separated streams meet at an angle that allows them to be mixed, in this case an angle substantially equal to 90°. The circulation network 4 thus uses flow directions in the three spatial dimensions, with fluid streams in the two separate planes P1 and P2 and streams that join the two planes.

The flow of fluid can thus be subdivided into separate streams that pass above the mixing member 10 and below this mixing member 10, respectively.

Thus, the two separated streams lead into the mixing zone 54 at respective angles that are selected so as to generate a mixture of wall layers of fluid and inner layers of fluid in the mixing zone 54.

The fluid can thus have a lower temperature on the wall of the upper plate 2, which acts as a thermal interface in order to offer a better heat exchange with the components to be cooled.

In the present invention, the mixing can take place at relatively low speeds of the fluid, said mixing being chaotic by virtue of the angles selected for the two flows that lead into the mixing zone.

In the example described, the mixing member 10 extends substantially over the entire length of the associated channel 5.

The openings 11 in the mixing member are identical and are regularly spaced apart from one another.

The space between the first opening 11 and the last opening 11 of a row represents at least 90% of the dimension of the mixing member 10, said dimension being measured parallel to this row.

Thus, the openings 11 occupy a large surface area of the mixing member 10.

In the example described, the mixing member 10 comprises 5 parallel rows of openings 11.

Each opening 11 comprises a longitudinal branch 18 to which two transverse branches 19 are connected, as can be seen in FIG. 3.

The mixing member 10 has a periphery that is adapted to the form of the channel 5 in which it is placed, which is in this case generally rectangular.

Each channel 5 receives a mixing member 10, which is an additional member that is placed in the channel.

In the example described, the mixing member 10 is a monolithic part, which is produced by injection molding and arranged to orient the fluid streams.

In this case, the openings 11 in the mixing member 10 are configured to define cylindrical portions 52 for the passage of fluid.

In the example described, the mixing member 10 is placed in a tank 17, as can be seen in FIG. 2, and this mixing member 10 and this tank 17 together define the fluid flow channels 5.

The tank 17 is formed by the lower plate 3 and closed by the planar upper plate 2, and the mixing member 10 bears against the two plates 2 and 3 forming the tank 17, covering the entire flat bottom of the tank 17.

In this example, the neighboring channels 5 are separated by the mixing member 10 rather than by the lower plate 3, which is planar on the bottom.

In another exemplary embodiment illustrated in FIG. 5, the mixing member 20 is not monolithic, in a single part, but has two assembled sheets 21 and 22.

These sheets 21 and 22 are provided with circulation orifices 23 that together form the openings 11 in the mixing member 20 that define fluid bifurcations and intersections.

The two sheets 21 and 22 can replace the abovementioned monolithic mixing member 10. Once assembled, these sheets 21 and 22 form the same fluid paths as the mixing member 10.

These sheets 21 and 22 are adhesively bonded to one another, or, in a variant, are laser welded to one another. This is advantageous in order to avoid the sheets being heated when they are made of a plastics-based composite material filled with reinforcing elements such as glass fibers or carbon fibers.

In the above-described examples, it is mainly the mixing member 10 or 20 that orients the fluid streams, the upper 2 and lower 3 plates mainly acting as casing for the channels 5, without the role of orienting the fluid for separating and recombining the streams.

In another exemplary embodiment illustrated in FIG. 6, the lower plate 3 comprises grooves 25 forming, with the upper plate 2, which is planar, the parallel channels 5.

Each channel 5 receives an associated mixing member 10 or 20.

The grooves 25 in the lower plate are formed by stamping the plate 3.

In another exemplary embodiment of the invention, the sheets 21 and 22 are aluminum-based, in particular being made of aluminum alloy, and are assembled with the lower 3 and upper 2 plates by brazing on the edges.

In another example illustrated in FIG. 7, the channels 5 are formed by assembling a stamped plate 31 and a mixing member 32, the stamped plate 31 comprising forms 33 for defining, with openings 34 in the mixing member 32, the channels 5 and zones for separating 51 and mixing 54 fluid as described in the preceding examples.

The stamped plate 31 is a wall encasing the channels 5, for example, which replaces the lower plate 3 described above.

The mixing member 32 comprises a single sheet 35 with the fluid circulation openings 34.

The openings 34 in the sheet 35 define, with the stamped forms 33 of the plate 31, fluid bifurcations and intersections, as described in the preceding examples.

The stamped forms 33 of the plate 31 form patterns that are repeated so as to correspond to the openings 34 in the mixing member 32.

Each stamped form 33 comprises a longitudinal branch 36 to which two transverse branches 37 are connected.

The stamped forms 33 are dishes on the plate 31.

This branch configuration on the plate 31 has mirror symmetry that is offset with respect to the branch configuration of the patterns on the mixing member 32, in order to form the fluid bifurcations and intersections.

The mixing member 32 may be based on plastics material, composite material, ceramic or metal.

1. A device for thermal regulation, for a component that is liable to release heat during operation, the device having a circulation network for a heat-transfer fluid, the circulation network comprises:
a fluid flow channel; and
a mixing member comprises openings that are arranged so as to cause the fluid circulating in the channel to be successively separated and mixed.

2. The device as claimed in claim 1,
wherein the channel comprises at least one wall formed by a plate or a tube,
wherein the plate or the tube, on the one hand, and the mixing member, on the other hand, are separate parts.

3. The device as claimed in claim 2, wherein the mixing member is in the form of an additional member that is placed in the channel.

4. The device as claimed in claim 2,
wherein the plate or the tube, and the mixing member are made from different materials,
wherein the mixing member is made of plastics material or plastics-based composite material, and the plate or the tube is made of metal.

5. The device as claimed in claim 1,
wherein the channel and the mixing member are arranged so as to define at least one separation zone,
wherein the at least one separation zone being arranged so as to separate the flow of fluid into at least two separated streams and, downstream, a mixing zone in which the two separated streams mix.

6. The device as claimed in claim 5,
wherein the at least two separated streams lead into the mixing zone at respective angles that are selected so as to generate a mixture of wall layers of fluid and inner layers of fluid in the mixing zone,
wherein the angle of incidence between the two streams of fluid leading into the mixing zone being between 45° and 90°,
wherein the angle being defined with respect to a z axis.

7. The device as claimed in claim 1, wherein the mixing member and the channel are configured to generate fluid streams that are in at least two parallel planes that are spaced apart from one another by a height.

8. The device as claimed in claim 1, wherein the mixing member is a monolithic part arranged so as to orient the fluid streams.

9. The device as claimed in claim 1,
wherein the mixing member has at least two assembled sheets,
wherein the at least two assembled sheets being provided with circulation orifices that together form the openings in the mixing member that define fluid bifurcations and intersections.

10. The device as claimed in claim 1, wherein the mixing member is placed in a tank, and the mixing member and the tank together define the fluid flow channels.

11. The device as claimed in claim 1,
wherein the channels are formed by assembling a stamped plate and the mixing member,
wherein the stamped plate comprising forms for defining, with forms of the mixing member, the channels and zones for separating and mixing fluid.

12. The device as claimed in claim 1,
wherein the circulation network further comprising a fluid flow portion downstream of a mixing zone, such that the fluid flowing in this fluid flow portion has a relatively homogeneous temperature as a result of the mixing in the mixing zone,
wherein the downstream flow portion has a cross section for a passage of fluid that is larger than each of the cross sections of the separated fluid flows.

13. An assembly having a component that is liable to release heat during operation, and the device as claimed in claim 1, in contact with which the component is cooled.
